(19) United States
(12) Patent Application Publication
(10) Pub. No.: US 2018/0015601 A1
(43) Pub. Date: Jan. 18, 2018

(54) STAPLER WITH A MOVEABLE STAPLE PRESSING MECHANISM

(71) Applicant: SDI CORPORATION, Chang Hua (TW)

(72) Inventor: Ching-Li Chen, Chang Hua (TW)

(73) Assignee: SDI CORPORATION, Chang Hua (TW)

(21) Appl. No.: 15/213,081

(22) Filed: Jul. 18, 2016

(51) Int. Cl. B25C 5/02

(52) U.S. Cl. CPC B25C 5/025

(57) ABSTRACT

A stapler with a movable staple pressing mechanism has a base, a magazine assembly, an arm assembly, and a staple pressing mechanism. The magazine assembly is pivoted on the base and has a magazine. The arm assembly is pivoted on the base, is located above the magazine assembly, and has a trigger lever and a staple pressing tab. The staple pressing mechanism is mounted between the magazine assembly and the arm assembly, and has a staple pressing base, a trigger elastic unit, and a restoring elastic unit. The staple pressing base is pivoted on the base and located in the magazine. The trigger elastic unit is mounted between the trigger lever and the staple pressing base. The restoring elastic unit is mounted between the arm assembly and the magazine assembly to provide a restoring elastic force for the staple pressing base.

### BACKGROUND OF THE INVENTION

### 1. Field of the Invention

The present invention relates to a stapler, and more particularly to a stapler with a moveable staple pressing mechanism.

### 2. Description of Related Art

When a conventional stapler is stapling, a user presses a trigger lever to press downwardly a staple pressing tab to press staples. A forefront staple placed in a magazine of the conventional stapler is separated from the remaining staples and is pressed toward a staple opening of the magazine by the staple pressing tab, and legs of the staple that is pressed out of the staple opening are bent on an anvil. Staples that are left in the conventional stapler are pushed forwards by a staple pushing unit to fill a vacancy of the staple that is pressed out of the staple opening, such that a stapling process is finished.

Partial structures and operational processes of a conventional large stapler 60 are shown in FIGS. 10 and 11. A magazine 61 of the conventional large stapler 60 is applicable for staples of long leg lengths, so the magazine 61 has a large accommodating space. If staples having short leg lengths are placed in the magazine 61 for use, a large interspace exists above the staples. A staple pressing tab 63 of the conventional large stapler 60 presses downwardly to press and separate a forefront staple 69 toward a staple opening of the magazine 61. When the staple pressing tab 63 finishes separating the staples 69 and is about to move upwardly, the staples 69 are pulled to move upwardly by the staple pressing tab 63 easily because the large interspace exists above the staples 69. The staples 69 will be rotated in the magazine 61 and be askew, and thus cannot be stapled continuously. Therefore, the conventional large stapler 60 is only applicable for staples 69 of a uniform size.

Partial structures and operational processes of another conventional stapler 70 having a staple holder are shown in FIGS. 12, 12A, 13, 13A, and 14. The staple holder is deposited for staples 79 to be mounted across the staple holder, and legs of the staples 79 can move steadily between the staple holder and a magazine. In use, an interval D is still formed between the staples 79 and a staple pressing base 72. When the stapler 70 is used to staple few staples 79, the staples 79 are rotated because of a pressing force of the staple pressing tab 74. When the legs of the staple 79 are rotated to leave an anvil range of an anvil of the conventional stapler 70 and the staple 79 is pressed out by the staple pressing tab 74, the legs of the staple 79 cannot be bent into shape.

As the aforementioned, the conventional stapler 60, 70 cannot be applicable for staples 69, 79 of different leg lengths. When the staples 69 having short leg lengths are used, the staples 69 are rotated and are easily askew because of being pulled upwardly by the staple pressing tab, such that the conventional stapler 60 cannot staple continuously. Even when the conventional stapler 70 having the staple holder is used to staple few staples, the legs of the staples 79 are easily rotated to leave the anvil range of the anvil because of the pressing force of the staple pressing tab. Therefore, poor stapling easily occurs. The abovementioned problems need to be resolved.

### SUMMARY OF THE INVENTION

To resolve problems that a conventional stapler cannot be applicable for staples of different leg lengths and poor stapling easily occurs, the main objective of the present invention is to provide a stapler with a movable staple pressing mechanism which can be applicable for staples of different leg lengths, and can effectively decrease occurrence of poor stapling.

The stapler with a movable staple pressing mechanism comprises a base, a magazine assembly, an arm assembly, and a staple pressing mechanism.

The magazine assembly is pivoted on the base, and comprises a magazine. The arm assembly is pivoted on the base, is located above the magazine assembly, and comprises a trigger lever and a staple pressing tab combined on the trigger lever. The staple pressing mechanism is mounted between the magazine assembly and the arm assembly, and comprises a staple pressing base, a trigger elastic unit, and a restoring elastic unit. The staple pressing base is pivoted on the base and is located in the magazine. The trigger elastic unit is mounted between the trigger lever and the staple pressing base. The restoring elastic unit is mounted between the arm assembly and the magazine assembly to provide a restoring elastic force for the staple pressing base.

From the above description, it is noted that when the stapler with a movable staple pressing mechanism of the present invention is in use, the staple pressing base can be pressed downwardly by the trigger elastic unit to press the staples placed in the magazine. When a user finishes stapling and releases the trigger lever, the staple pressing base is maintained at the status of pressing the staples, such that no space can be formed between the staples and the staple pressing base, and the staples cannot rotate. Therefore, the staples are not driven upwardly to rotate by the staple pressing tab. Also, when the arm assembly is pivoted upwardly to return to an original position, the staple pressing base is also driven to return to an original position by the restoring elastic force of the restoring elastic unit, thereby restoring the stapler with a movable staple pressing mechanism of the present invention to an original state. Therefore, the stapler with a movable staple pressing mechanism of the present invention can mitigate occurrence of poor stapling of the conventional stapler by the staple pressing base pressing the staples. Furthermore, the stapler with a movable staple pressing mechanism of the present invention can be applicable for staples of different leg lengths, such that the stapler of the present invention has a wider operability.

Other objectives, advantages and novel features of the present invention will become more apparent from the following detailed description when taken in conjunction with the accompanying drawings.

### BRIEF DESCRIPTION OF THE DRAWINGS

FIG. 1 is a perspective view of a first embodiment of a stapler with a movable staple pressing mechanism in accordance with the present invention;

FIG. 2 is a cross sectional perspective view of the stapler in FIG. 1;

FIG. 3 is a partially enlarged perspective view of the stapler in FIG. 2;

FIG. 4 is a side view in partial section of the stapler in FIG. 1;

FIG. 5 is an operational process of the stapler in FIG. 1;

FIG. 6 is a perspective view of a second embodiment of a stapler with a movable staple pressing mechanism in accordance with the present invention;

FIG. 7 is a partially enlarged perspective view of the stapler in FIG. 6;

FIG. 8 is a side view in partial section of the stapler in FIG. 6;

FIG. 9 is an operational process of the stapler in FIG. 8;

FIGS. 10 and 11 are operational processes of a large stapler in accordance with the prior art; and

FIGS. 12, 12A, 13, 13A, and 14 are operational processes of another stapler with a staple holder in accordance with the prior art.

### DETAILED DESCRIPTION OF PREFERRED EMBODIMENT

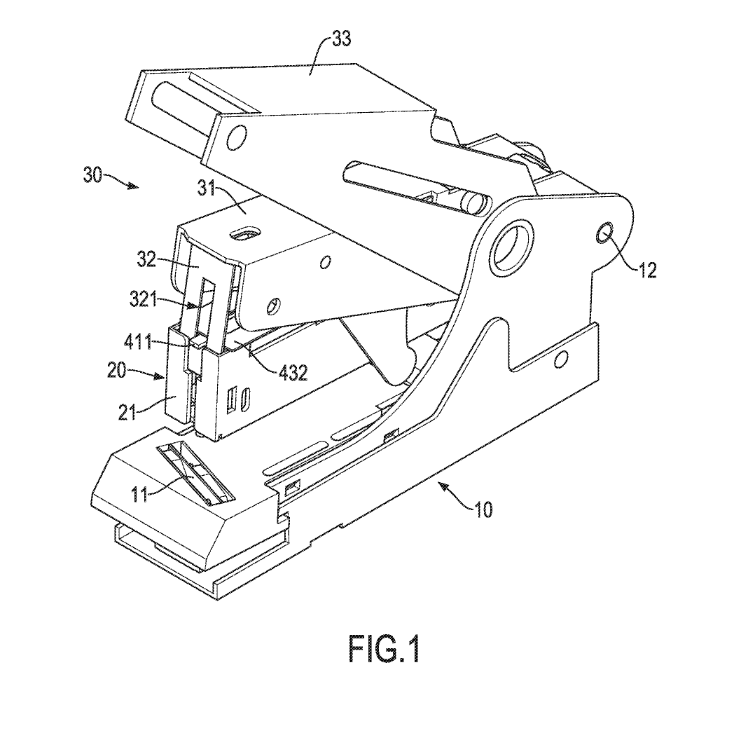

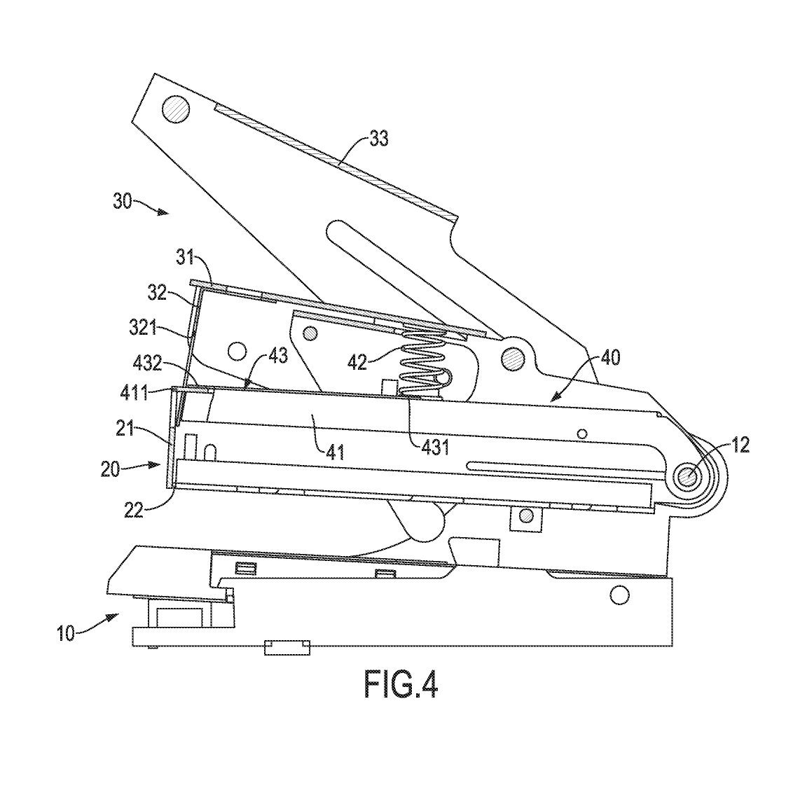

With reference to FIGS. 1 to 4, a first embodiment of a stapler with a movable staple pressing mechanism in accordance with the present invention comprises a base 10, a magazine assembly 20, an arm assembly 30, and a staple pressing mechanism 40. The base 10 comprises an anvil structure 11 disposed on a front end of the base 10. A pivot unit 12 is mounted on a rear end of the magazine assembly 20 and a rear end of the base 10, such that the magazine assembly 20 is pivoted on the base 10 by the pivot unit 12. The magazine assembly 20 comprises a magazine 21. A staple opening 22 is formed on a bottom of a front end of the magazine 21, and a position of the staple opening 22 corresponds to that of the anvil structure 11.

The arm assembly 30 is located above the magazine assembly 20, and a rear end of the arm assembly 30 is pivoted on the rear end of the base 10 by the pivot unit 12. The arm assembly 30 comprises a trigger lever 31 pivoted on the base 10 by a rear end of the trigger lever 31. The arm assembly 30 also comprises a staple pressing tab 32 combined on a front end of the trigger lever 31, and a position of the staple pressing tab 32 corresponds to those of the staple opening 22 and the anvil structure 11. The staple pressing tab 32 is applied for pressing downwardly one of the staples placed in the magazine 21 out of the staple opening 22 and towards the anvil structure 11. The arm assembly 30 further comprises an auxiliary lever 33. A rear end of the auxiliary lever 33 is pivoted on the base 10 and is located above the trigger lever 31.

The auxiliary lever 33 may be combined with a top cover made of plastic or metal to assist a user with pressing the stapler. In use, because the user presses the arm assembly 30 downwardly, the auxiliary lever 33 is pivoted and moved downwardly relative to the base 10 to drive the trigger lever 31 to be pivoted downwardly to achieve an effort-saving effect. The base 10, the magazine assembly 20, and the arm assembly 30 may be conventional, and the structures of the base 10, the magazine assembly 20, and the arm assembly 30 are not elaborated in the present invention.

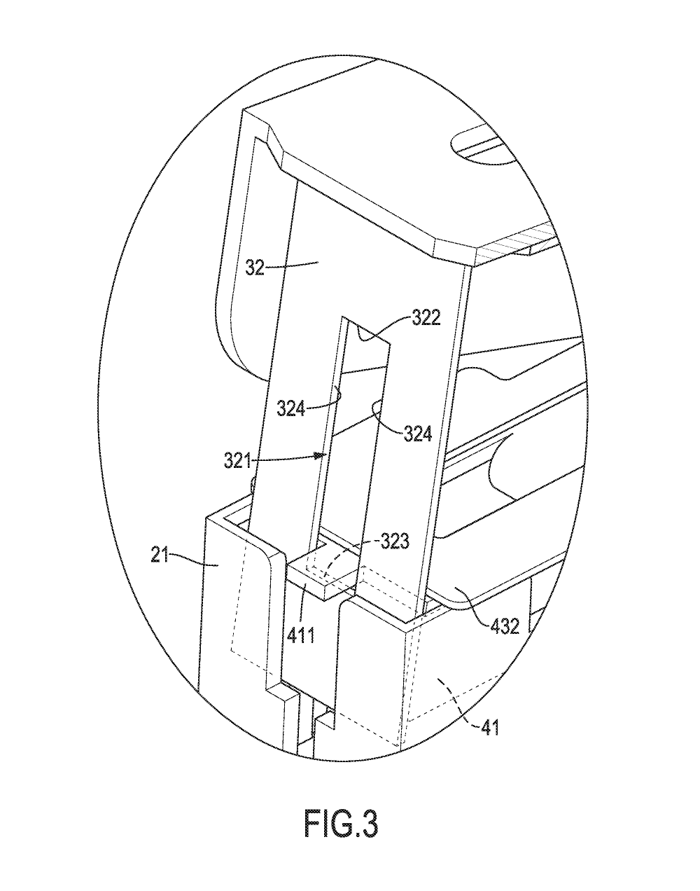

The staple pressing mechanism 40 is mounted between the magazine assembly 20 and the arm assembly 30, and comprises a staple pressing base 41, a trigger elastic unit 42, and a restoring elastic unit 43. The staple pressing base 41 is pivoted on the base 10 and is located in the magazine 21. A rear end of the staple pressing base 41 is pivoted on the pivot unit 12 of the base 10, and can be pivoted relative to the magazine 21. Further with reference to FIG. 3, an elongated slot 321 is formed through a middle position on the staple pressing tab 32. The slot 321 has a top 322, a bottom 323, and two sides 324 respectively on a left and a right of the slot 321. A protrusion 411 is formed on and protrudes from a front end of the staple pressing base 41, is inserted through the slot 321, and relatively moves between the top 322 and the bottom 323 of the slot 321. The slot 321 is applied for limiting pivot travel of the trigger lever 31 relative to the magazine assembly 20.

Amounts of the slot 321 and the protrusion 411 are not limited in the present invention. The staple pressing tab 32 may comprise two slots respectively formed on two sides of the staple pressing tab 32. The staple pressing base 41 may comprise two protrusions respectively formed on two sides of the front end of the staple pressing base 41 and respectively inserted through the slots of the staple pressing tab 32.

The trigger lever 31 comprises a bottom surface, and the staple pressing base 41 comprises a top surface. The trigger elastic unit 42 is mounted between the bottom surface of the trigger lever 31 and the top surface of the staple pressing base 41. The trigger elastic unit 42 may be a compression spring or a flat spring. Preferably, the trigger elastic unit 42 is a compression spring. When the auxiliary lever 33 and the trigger lever 31 are forced downwardly by the user to be pivoted and move downwardly, the trigger elastic unit 42 will be compressed to drive the staple pressing base 41 to be pivoted downwardly.

The restoring elastic unit 43 is mounted between the arm assembly 30 and the magazine assembly 20 to provide a restoring elastic force for the staple pressing base 41. The restoring elastic unit 43 has a first end 431 and a second end 432 opposite the first end 431. The first end 431 is mounted on one of the staple pressing base 41 and the trigger lever 31. The second end 432 is mounted on the magazine 21. When the trigger lever 31 and the staple pressing base 41 are pivoted downwardly, the first end 431 of the restoring elastic unit 43 will move along with one of the staple pressing base 41 and the trigger lever 31. When the trigger lever 31 is released from the user, the restoring elastic unit 43 is provided with the restoring elastic force via the second end 432.

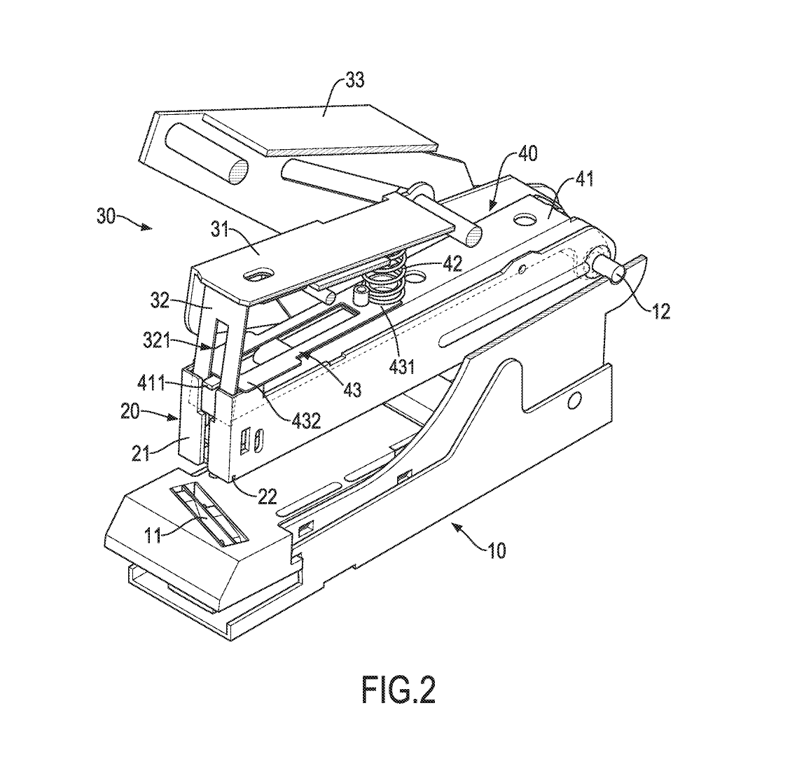

With reference to FIG. 2, in the first embodiment, the restoring elastic unit 43 is an elongated flat spring. The first end 431 is located on a rear end of the restoring elastic unit 43, and the second end 432 is located on a front end of the restoring elastic unit 43. The first end 431 is mounted on the staple pressing base 41. Preferably, the first end 431 is riveted on the staple pressing base 41, and the second end 432 is mounted across and abuts on the magazine 21.

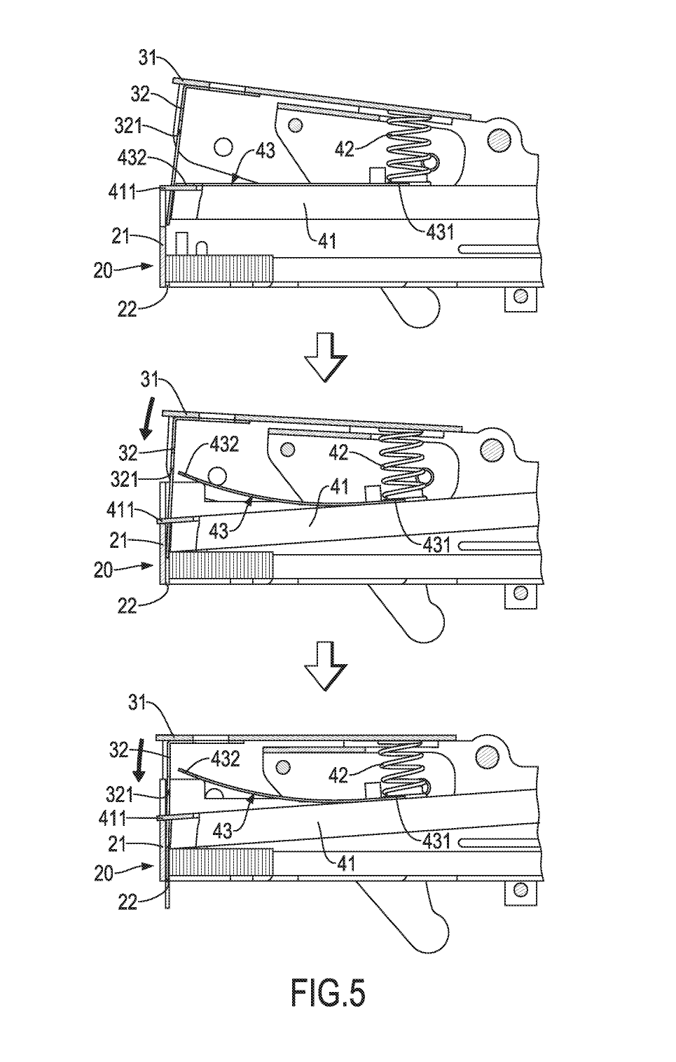

Operational states of the first embodiment are shown in FIGS. 2 to 5. Before stapling, the restoring elastic unit 43 is flush with the staple pressing base 41 and makes the staple pressing base 41 parallel with the magazine 21. During stapling, the arm assembly 30 is pivoted and moves downwardly relative to the base 10 because of being pressed downwardly by the user. Because the staple pressing base 41 can be pivoted relative to the magazine 21, the trigger lever 31 will compress the trigger elastic unit 42 to drive the staple pressing base 41 to be pivoted downwardly relative to the magazine 21 to press staples placed in the magazine 21. At the same time, the first end 431 of the restoring elastic unit 43 moves downwardly along with the staple pressing base 41, and the second end 432 is limited on the magazine 21 and is limited from moving, such that the restoring elastic unit 43 can store the restoring elastic force. Then, the user further forces on the arm assembly 30 to make the arm assembly 30 and the magazine assembly 20 fall instantaneously towards the anvil structure 11 of the base 10, such that one of the staples placed in the magazine 21 is pushed out from the magazine 21 by the staple pressing tab 32 and is bent into shape by the anvil stricture 11.

After stapling, the arm assembly 30 is released from the user, and the arm assembly 30 will be pivoted upwardly to return to an original position. The staple pressing base 41 is also driven to be pivoted upwardly to return to an original position by the first end 431 of the restoring elastic unit 43. When the staple pressing tab 32 is moving upwardly, the staples placed in the magazine 21 remain pressed by the staple pressing base 41, such that the staples placed in the magazine 21 will not be driven to rotate by the staple pressing tab 32. Even staples having short leg lengths are placed in the magazine 21, the staples also can be pressed firmly by the staple pressing base 41. Therefore, the stapler with a movable staple pressing mechanism of the present invention can be applied for staples of different leg lengths. Furthermore, the staples placed in the magazine 21 are not rotated, such the staples can be stapled continuously to mitigate occurrence of poor stapling of a conventional stapler.

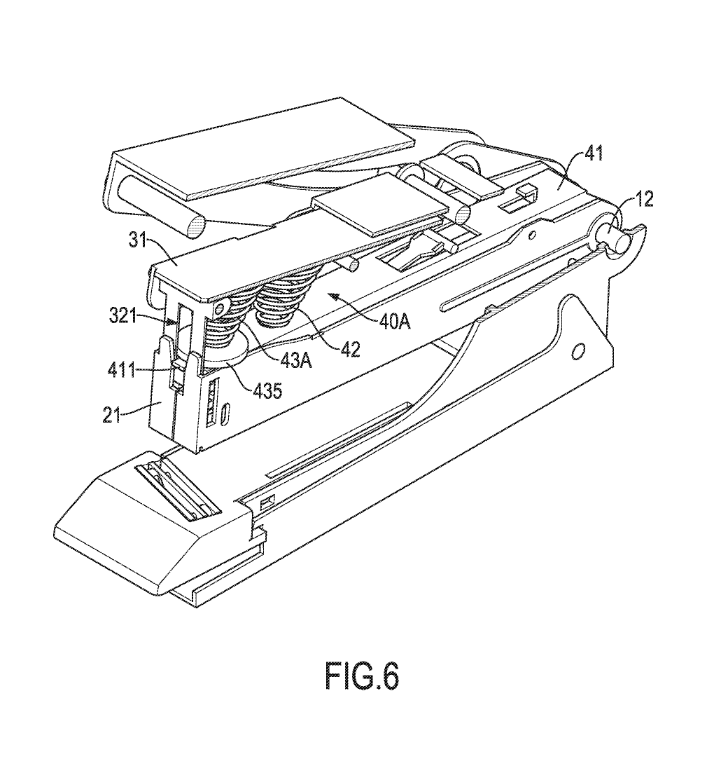

A second embodiment of the stapler with a movable staple pressing mechanism in accordance with the present invention is shown in FIGS. 6 to 8. The second embodiment is different from the first embodiment because of a structure of the staple pressing mechanism 40A. The restoring elastic unit 43A of the staple pressing mechanism 40A is a compression spring, and has a top end and a bottom end. The first end 431A is formed on the top end of the restoring elastic unit 43A and is connected with the trigger lever 31. The second end 432A is formed on the bottom end of the restoring elastic unit 43A and is mounted on the magazine 21. The restoring elastic unit 43A is elastically connected between the magazine 21 and the trigger lever 31 to provide a restoring elastic force for the staple pressing base 41.

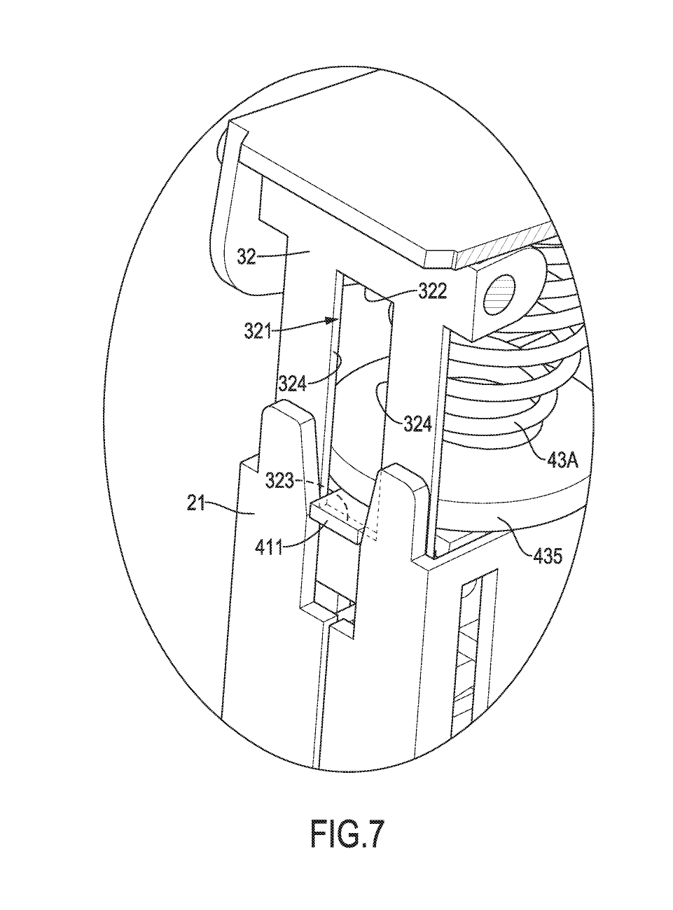

Further with reference to FIG. 7, the protrusion 411 on the front end of the staple pressing base 41 is inserted through the slot 321 of the staple pressing tab 32, and relatively moves between the top 322 and the bottom 323 of the slot 321. The pivot travel of the trigger lever 31 relative to the magazine 21 is limited by the slot 321 of the staple pressing tab 32. When the restoring elastic unit 43A provides the restoring elastic force for the trigger lever 31 to drive the trigger lever 31 to move upwardly, the trigger lever 31 will pull upwardly the protrusion 411 by the bottom 323 of the slot 321 of the staple pressing tab 32, such that the staple pressing base 41 can return to move upwardly to the original position. Preferably, the restoring elastic unit 43A further comprises a gasket 435 located on the bottom end of the restoring elastic unit 43A, mounted across and abutting on the magazine 21. Therefore, the restoring elastic unit 43A can abut the magazine 21 firmly by the gasket 435, and when the restoring elastic unit 43A is compressed, the restoring elastic unit 43A can provide a stable and firm restoring elastic force for the staple pressing base 41.

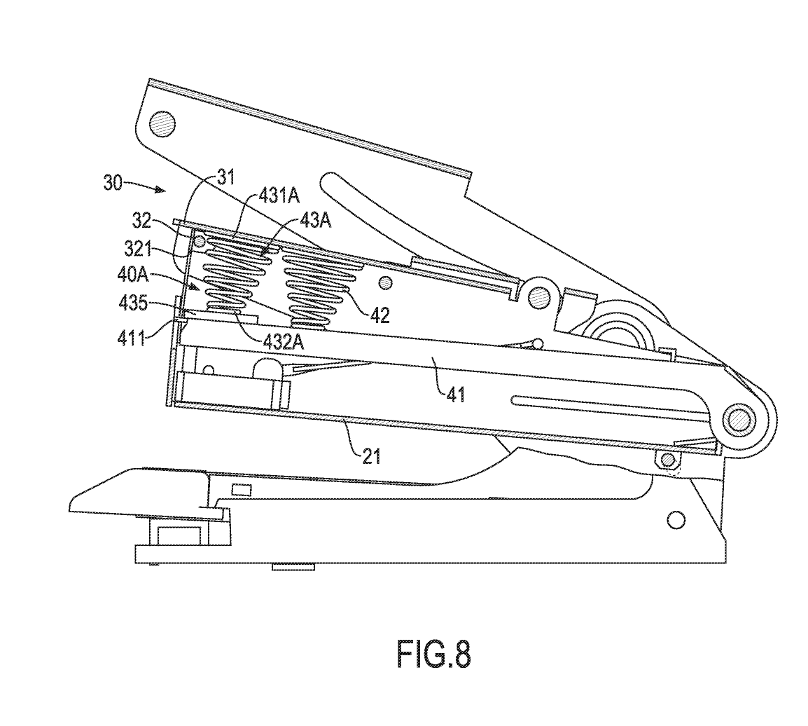

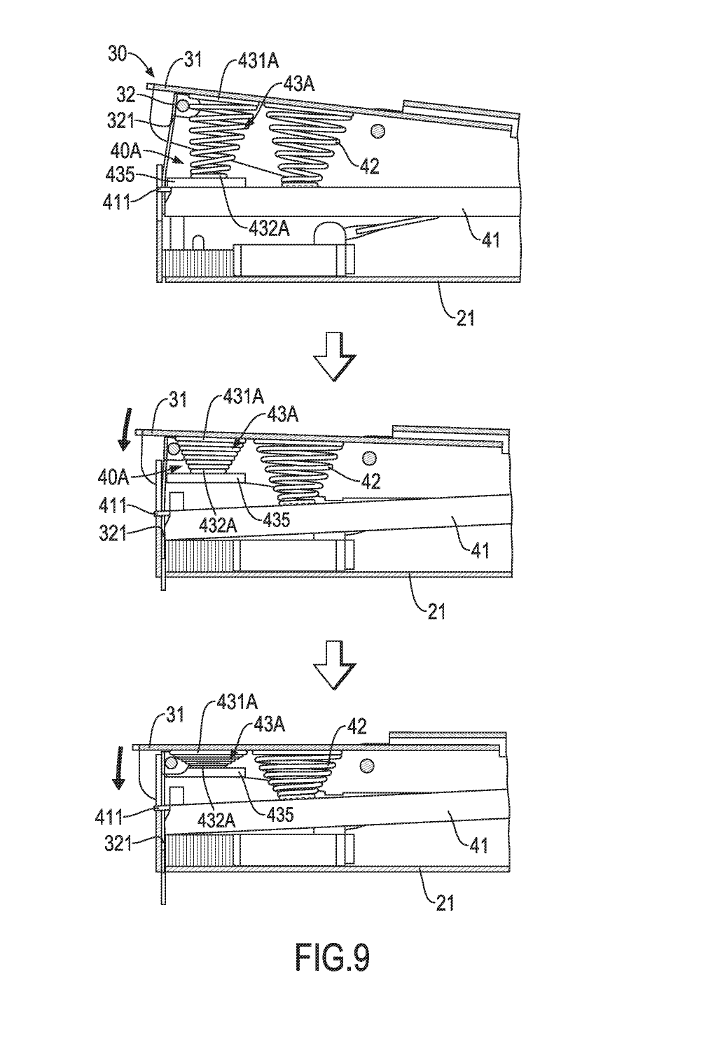

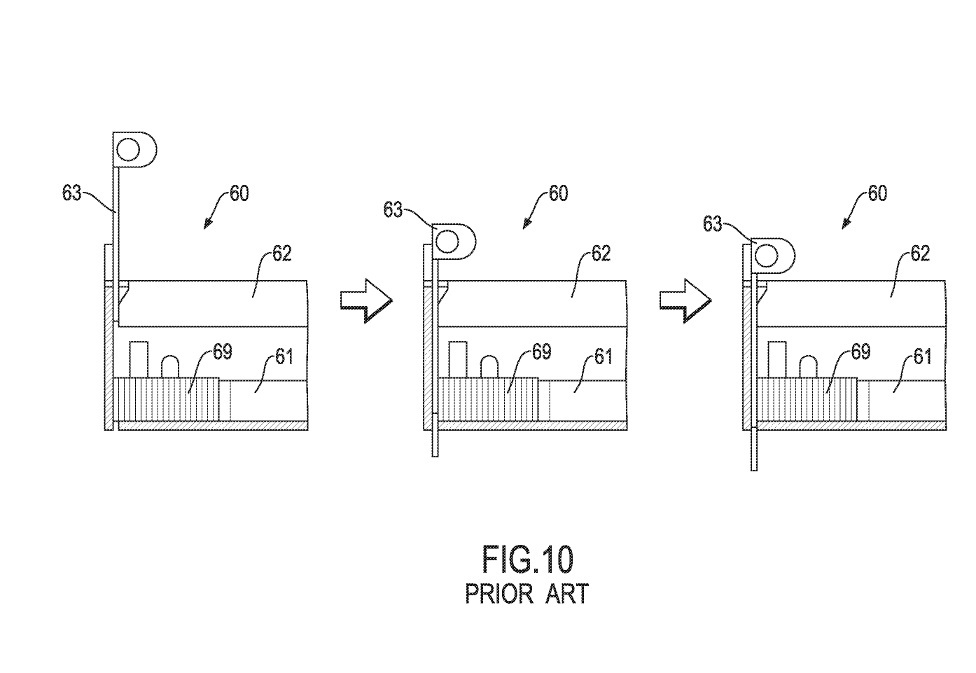

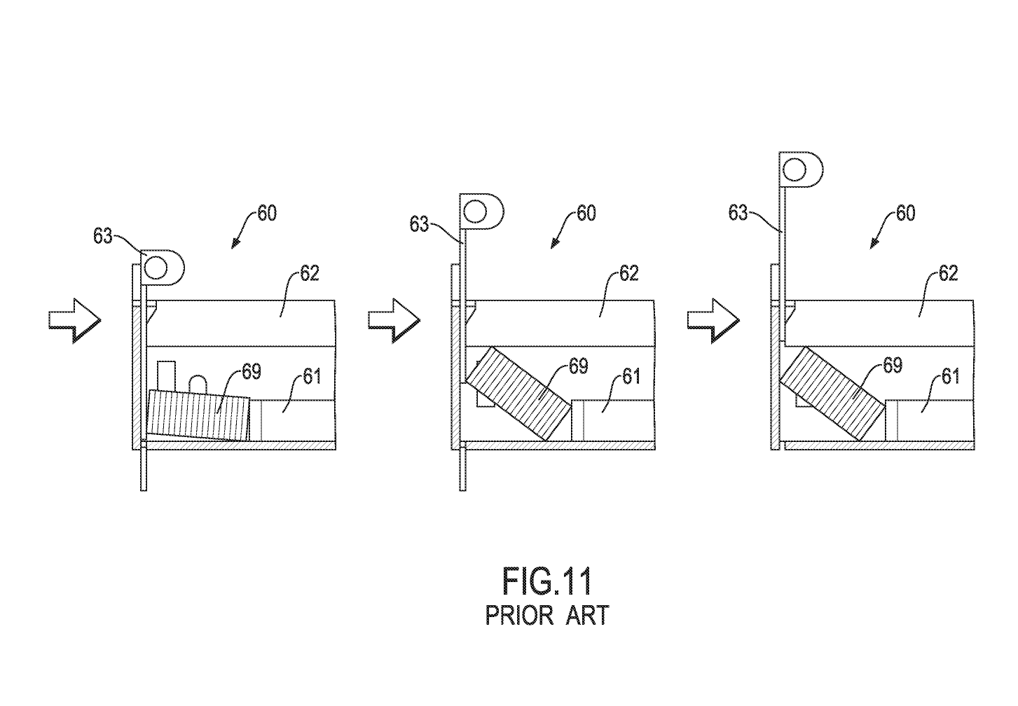

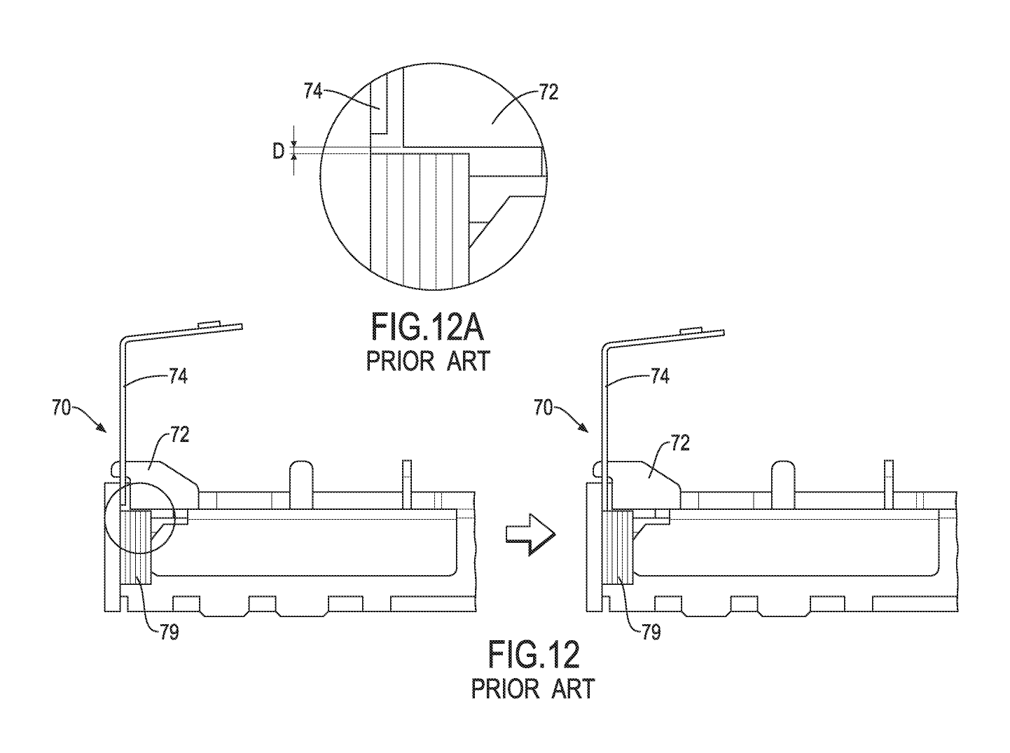

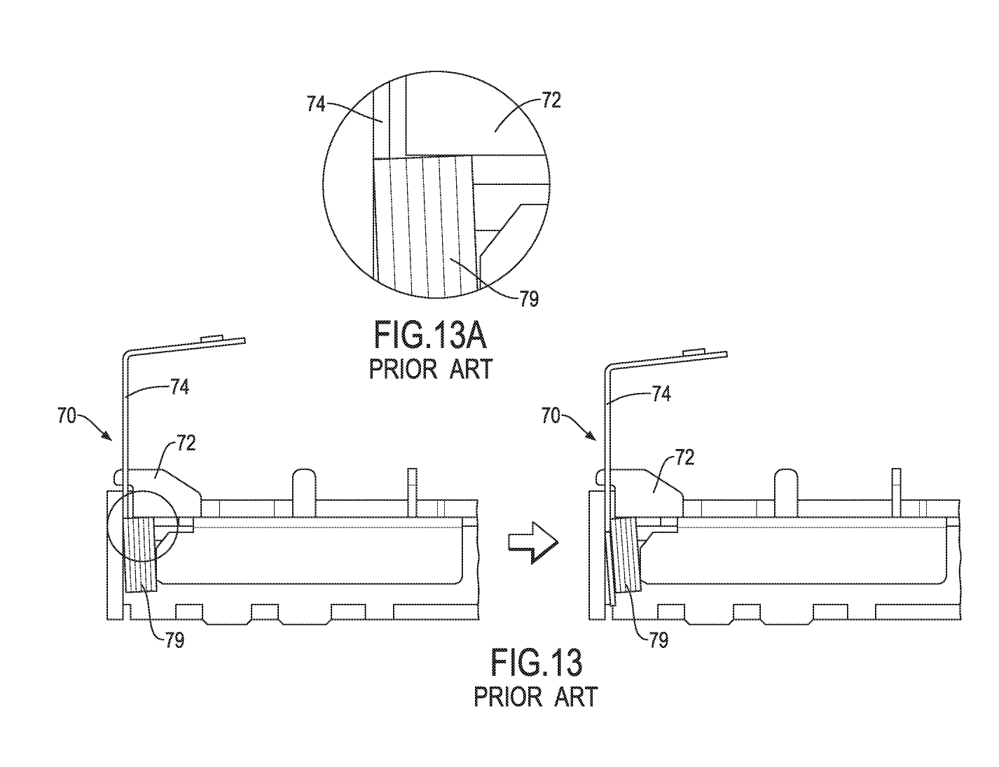

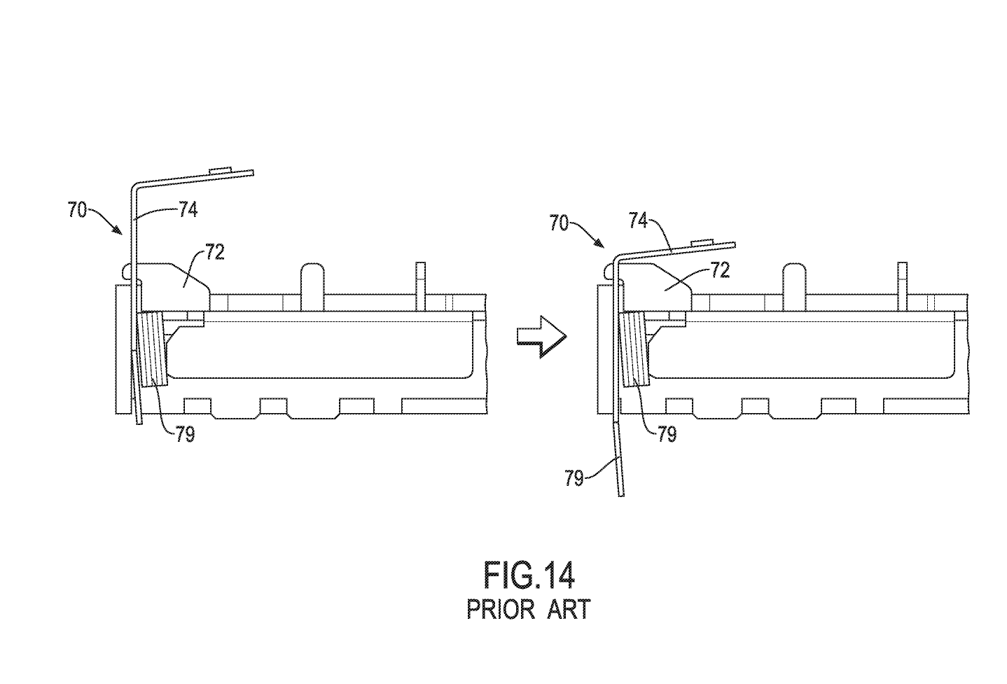

With reference to FIG. 8, before stapling, the trigger lever 31 is pushed upwardly by an elastic force of the trigger elastic unit 42. The staple pressing tab 32 pushes the protrusion 411 by the bottom 323 of the slot 321 to pull the staple pressing base 41 upwardly, such that the staple pressing base 41 is flush with the magazine 21 and is not to contact the staples placed in the magazine 21. Further with reference to FIG. 9, during stapling, the arm assembly 30 is pivoted and moved downwardly relative to the base 10 because the user presses downwardly on the arm assembly 30.

When the trigger lever 31 is pressed downwardly, the trigger elastic unit 42 is compressed to drive the staple pressing base 41 to be pivoted downwardly relative to the magazine 21 to press the staples placed in the magazine 21. At the same time, the second end 432A of the restoring elastic unit 43A is limited on the magazine 21 and is limited from moving, and the first end 431A is compressed to store the restoring elastic force. Then, the user further presses the arm assembly 30 to staple. After stapling, the arm assembly 30 is released from the user, and the restoring elastic unit 43A provides the restoring elastic force for the trigger lever 31 to drive the trigger lever 31 to be pivoted upwardly.

When the trigger lever 31 is pivoted upwardly, the bottom 323 of the slot 321 of the staple pressing tab 32 pulls upwardly the protrusion 411 of the staple pressing base 41 to drive the staple pressing base 41 to move upwardly, and the staple pressing base 41 can be pivoted upwardly to return to the original position as shown in FIG. 8. During stapling, the staples placed in the magazine 21 remain pressed by the staple pressing base 41, so the staples placed in the magazine 21 will not be driven to rotate by upward movement of staple pressing tab 32. Even staples having short leg lengths are placed in the magazine 21, the staples also can be pressed firmly by the staple pressing base 41. Therefore, the stapler with a movable staple pressing mechanism in accordance with the present invention can be applied for staples of different leg lengths. Furthermore, the staples placed in the magazine 21 are not rotated, such that the staples can be stapled continuously to mitigate occurrence of poor stapling.

Therefore, when the stapler with a movable staple pressing mechanism of the present invention is in use, the staple pressing base 41 can be pressed downwardly by the trigger elastic unit 42 to press the stapler downwardly. The staple pressing tab 32 can press a forefront staple out of the staple opening 22 of the magazine 21 to finish the stapling. Then, the arm assembly 30 is released from the user, and the staple pressing tab 32 will leave the magazine 21 along with the trigger lever 31. At the time, the staple pressing base 41 is maintained at the status of pressing the staples placed in the magazine 21, such that no space can be formed between the staples and the staple pressing base 41, and the staples cannot be rotated. Therefore, when the staple pressing tab 32 moves upwardly, the staples are not driven to be rotated. The restoring elastic unit 43, 43A is mounted between the arm assembly 30 and the magazine assembly 20 to provide the restoring elastic force for the staple pressing base 41, such that the staple pressing base 41 can move upwardly to return to the original position. Therefore, the stapler with a movable staple pressing mechanism of the present invention can use the staple pressing mechanism 40, 40A to press the staples during stapling to mitigate the poor stapling of the conventional stapler. The stapler of the present invention can be applicable for staples of different leg lengths, such that the stapler with a movable staple pressing mechanism of the present invention can be used as a handheld stapler of an ordinary size, or be used as a large stapler applicable for staples of long leg lengths to staple 70, 100, or more sheets of paper in large quantity.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A stapler with a movable staple pressing mechanism comprising:
a base;
a magazine assembly pivoted on the base, and comprising a magazine;
an arm assembly pivoted on the base, located above the magazine assembly, and comprising
a trigger lever; and
a staple pressing tab combined on the trigger lever; and
a staple pressing mechanism mounted between the magazine assembly and the arm assembly, and comprising
a staple pressing base pivoted on the base and located in the magazine;
a trigger elastic unit mounted between the trigger lever and the staple pressing base; and
a restoring elastic unit mounted between the arm assembly and the magazine assembly to provide a restoring elastic force for the staple pressing base.

2. The stapler with a movable staple pressing mechanism as claimed in claim 1, wherein
the restoring elastic unit has a first end and a second end opposite the first end; and
the first end is mounted on one of the staple pressing base and the trigger lever; and the second end is mounted on the magazine.

3. The stapler with a movable staple pressing mechanism as claimed in claim 2, wherein the restoring elastic unit is an elongated flat spring.

4. The stapler with a movable staple pressing mechanism as claimed in claim 3, wherein the first end is located on a rear end of the restoring elastic unit, the second end is located on a front end of the restoring elastic unit, and the first end is mounted on the staple pressing base.

5. The stapler with a movable staple pressing mechanism as claimed in claim 4, wherein the first end is riveted on the staple pressing base.

6. The stapler with a movable staple pressing mechanism as claimed in claim 4, wherein the second end is mounted across and abuts on the magazine.

7. The stapler with a movable staple pressing mechanism as claimed in claim 1, wherein the trigger elastic unit is a compression spring.

8. The stapler with a movable staple pressing mechanism as claimed in claim 2, wherein the restoring elastic unit has a top end and a bottom end, the first end and the second end are respectively formed on the top end and the bottom end of the restoring elastic unit, and the first end is mounted on the trigger lever.

9. The stapler with a movable staple pressing mechanism as claimed in claim 8, wherein the restoring elastic unit further comprises a gasket located on the bottom end of the restoring elastic unit and mounted across and abutting on the magazine.

10. The stapler with a movable staple pressing mechanism as claimed in claim 1, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

11. The stapler with a movable staple pressing mechanism as claimed in claim 2, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

12. The stapler with a movable staple pressing mechanism as claimed in claim 3, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

13. The stapler with a movable staple pressing mechanism as claimed in claim 4, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

14. The stapler with a movable staple pressing mechanism as claimed in claim 5, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

15. The stapler with a movable staple pressing mechanism as claimed in claim 6, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

16. The stapler with a movable staple pressing mechanism as claimed in claim 7, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

17. The stapler with a movable staple pressing mechanism as claimed in claim 8, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.

18. The stapler with a movable staple pressing mechanism as claimed in claim 9, wherein
at least one slot is formed through the staple pressing tab, and each one of the at least one slot has a top and a bottom; and
at least one protrusion is formed on the staple pressing base, and each one of the at least one protrusion is respectively inserted through each one of the at least one slot and relatively moves between the top and the bottom relative to the corresponding slot.
